(19) United States
(12) Patent Application Publication
(10) Pub. No.: US 2010/0225648 A1
(43) Pub. Date: Sep. 9, 2010

(54) STORY DEVELOPMENT IN MOTION PICTURE

(75) Inventors: Yiotis Katsambas, Playa Vista, CA (US); Dave Morehead, Los Angeles, CA (US); James Williams, Newbury Park, CA (US); Umberto Lazzari, Los Angeles, CA (US); Tok Braun, Los Angeles, CA (US); Andrea Miloro, Los Angeles, CA (US)

Correspondence Address: PROCOPIO, CORY, HARGREAVES & SAVITCH LLP, 525 B STREET, SUITE 2200, SAN DIEGO, CA, 92101, US

(73) Assignees: SONY CORPORATION, Tokyo (JP); SONY PICTURES ENTERTAINMENT INC., Culver City, CA (US)

(21) Appl. No.: 12/398,755

(22) Filed: Mar. 5, 2009

(51) Int. Cl. G06T 15/20

(52) U.S. Cl. 345/427

(57) ABSTRACT

Developing a story for a motion picture, including: receiving drawings; receiving camera setups by generating an animated 3-D environment; incorporating placeholders for the drawings into the generated 3-D environment; creating shots by ordering and timing the camera setups; and integrating the drawings into the camera setups.

### BACKGROUND

1. Field of the Invention

The present invention relates to motion picture, and more specifically, to developing storyboards, camera choices, and environments for a motion picture.

2. Background

The storyboarding process involves many panels of images drawn by a storyboard artist, and presented in order for the purpose of visualizing sections of a motion picture prior to production. An alternative process to storyboarding involves what is sometimes referred to as 3-D “pre-vis,” in which the story is visualized through the use of an “oversimplified” 3-D geometry that represents characters and environments. Each process offers advantages and disadvantages over the other. Pre-vis can provide more accurate timing information and spatial information than storyboards. However, pre-vis lacks the emotional aspect of drawn storyboards because the models are oversimplified.

### SUMMARY

Embodiments of the present invention can be used to visualize a story through the simultaneous use of drawn storyboards, visual development artwork, 3-D environments, and editing. Some embodiments include novel ways to integrate drawings with 3-D generated environments, and allow storyboard artists, visual development artists, editors, modelers, and layout artists to work in parallel when conceptualizing the motion picture in the early stage.

In one implementation, a method of developing story for a motion picture is disclosed. The method including: receiving drawings; receiving camera setups by generating an animated 3-D environment; incorporating placeholders for the drawings into the generated 3-D environment; creating shots by ordering and timing the camera setups; and integrating the drawings into the camera setups.

In another implementation, a method of developing story for a motion picture is disclosed. The method including: receiving drawings and camera setups; incorporating placeholders for the drawings; creating shots using position and timing of the camera setups; and integrating the drawings into the camera setups

In another implementation, a system for developing story for a motion picture is disclosed. The system including: a plurality of storyboard panels; a storyboard tool configured to generate 3-D scenes, wherein a 3-D scene includes virtual placement of 3-D cameras and setup of 3-D models; and a placeholder composer configured to incorporate placeholders for the plurality of storyboard panels into the generated scene.

In yet another implementation, a computer-readable storage medium storing a computer program for developing story for a motion picture is disclosed. The computer program including executable instructions that cause a computer to:

A computer-readable storage medium storing a computer program for developing a story for a motion picture, the computer program comprising executable instructions that cause a computer to: generate an animated 3-D environment when digitized drawings and camera setups are received; incorporate placeholders for the digitized drawings into the generated 3-D environment; create shots by ordering and timing the camera setups; and integrate the digitized drawings into the camera setups.

Other features and advantages of the present invention will become more readily apparent to those of ordinary skill in the art after reviewing the following detailed description and accompanying drawings.

### BRIEF DESCRIPTION OF THE DRAWINGS

FIG. 1A and FIG. 1B form a flowchart illustrating a story development process in accordance with one implementation of the present invention.

FIG. 2A through FIG. 2F illustrate one example of a sequence with storyboard panels, and integration of the panels into a generated 3-D environment.

FIG. 3 is a block diagram of a story development system in accordance with one implementation of the present invention.

FIG. 4A illustrates a representation of a computer system and a user.

FIG. 4B is a functional block diagram illustrating the computer system hosting the story development system.

FIG. 5 illustrates how a sequence edit viewer can simultaneously indicate setups, shots, and panels.

FIG. 6 includes one example of a story board panel.

FIG. 7 illustrates a rig is configured as a billboard rig, where the rig is always turned to face the active camera.

### DETAILED DESCRIPTION

The conventional processes, including storyboarding and 3-D “pre-vis” processes, involve the creation and tracking of a large number of assets. Further, these conventional processes do not easily allow the storyboard artists, visual development artists, editors, modelers, and/or layout artists to work in parallel in conceptualizing the motion picture during the story development stage.

Certain implementations as disclosed herein provide for a story development process including novel ways to integrate the storyboarding process with the 3-D scene/environment generation process to allow storyboard artists, visual development artists, editors, modelers, and layout artists to conceptualize the motion picture in the early stage.

After reading this description it will become apparent how to implement the invention in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present invention.

In one implementation, a method of developing story for a motion picture includes: generating or importing drawn storyboard panels; ordering and timing of those panels; automatic tracking modifications to any of the drawn panels; and generating editing variations.

In another implementation, a method of developing story for a motion picture includes: generating 3-D environments; providing the same action in a 3-D environment through multiple camera views (each view is referred to as a setup); allowing the creation of sequences by defining the order of the setup selection and the in-and-out point of each setup; and allowing the inclusion of drawn panels when a 3-D setup is not available.

In yet another implementation, a method of developing story for a motion picture includes: generating 3-D environments; creating placeholders for drawings within the 3-D environments; allowing an artist to attach drawings to those placeholders at key points; and the automatic incorporation of those drawings within the 3-D setups. Although references are made to the use of drawings, other visual media can be used in place of the drawings, such as photographs, video, or film footage.

In one implementation, a section of the story is described through the use of setups, shots, panels, and an edit. Some artists (e.g., most storyboard artists) prefer to think in terms of panels and benefit mostly by focusing on each panel. Other artists, such as story editors and animators, prefer to think in terms of shots. Further, other artists, such as cinematographers and layout artists, prefer to think in terms of setups.

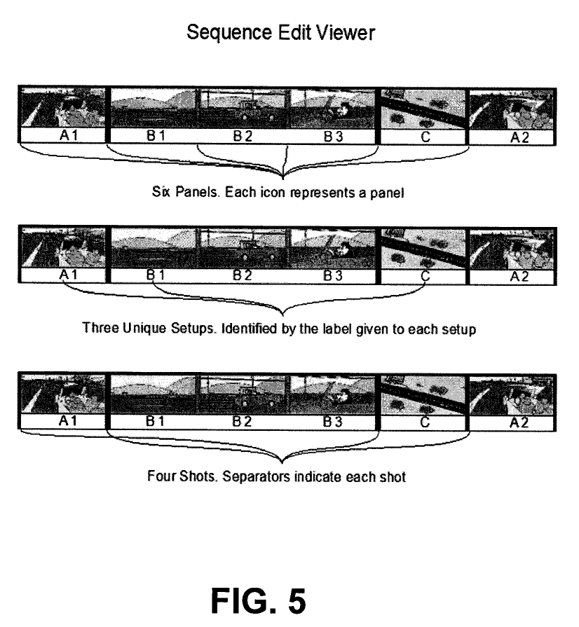

A setup represents the footage from a single camera view for the entire length of an action in a section of the story. A shot represents a section of a setup. As an example, a setup may be created that shows the back of the driver. Using that setup, an animated sequence is derived that shows the entire action from that camera view. When a section of that movie is used in the sequence edit, each section is referred to as a shot. A collection of shots form a single setup. An edit represents the collection of shots. A shot may include various key frames, such as a dialogue change, a character expression change, or a key action. Each of these key frames is referred to as a panel. Therefore, an edit or individual shot can either be played back or the viewer can step through the panels. The time information is used when playing back the shot while the time information is ignored when stepping through the panels. FIG. 5 illustrates how a sequence edit viewer can simultaneously indicate setups, shots, and panels.

The edit information along with setups and shot information are exported to editorial tools including an editor. The editor receives all of the setup footage, with indications of which shots were created and in what order (and suggested durations). The editor can modify the shots by redefining which sections of the setups are being used and in what order. The edit from an editorial can be re-imported to the story development tool and can automatically create an edit to re-link each shot to the source setup.

In a similar implementation, the sequence edit is exported to the editorial tools. The panels are sent as held frames rather than as a continuous movie, and each panel is edited to match the action defined in the originating shots. The editor can ignore the timing of the setup footage, and instead use the panel timing by using held panels rather than shots. For example, if the action defines characters engaged in conversation inside a car while the car is moving, and if the editor chooses to retime the movie to get the mouth expressions to match the audio, the speed of the car will be affected. However, the editor instead can choose to time the held panels. The panels can represent the change of character expressions as characters converse. Accordingly, the speed of the car is ignored, and the edit represents the timing of the expression change. The edit can then be re-imported into the story development tool. An artist can generate a new variation of the setup that matches the timing of the edited panels, while maintaining the original speed of the car.

In one implementation, a story development process includes a tool that integrates the work of storyboard artists, visual development artists, editors, modelers, and layout artists. In particular, the tool allows integration of a sketch/panel drawing process, visual development artwork, and a 3-D setup/environment generation process. This allows 3-D artists to create complex 3-D setups, and allows storyboard artists to integrate the storyboard panels within the 3-D scenes.

The story development tool includes a concept of rigs which are placeholders for panel drawings that are added in a scene by a 3-D artist. Types of rigs (which are described below in detail) include: billboard, multi-plane, projection, UV, and camera billboard. The story development tool also includes modes which make drawings, 3-D environments, and/or timing optional. The story development tool is configured on a platform independent system.

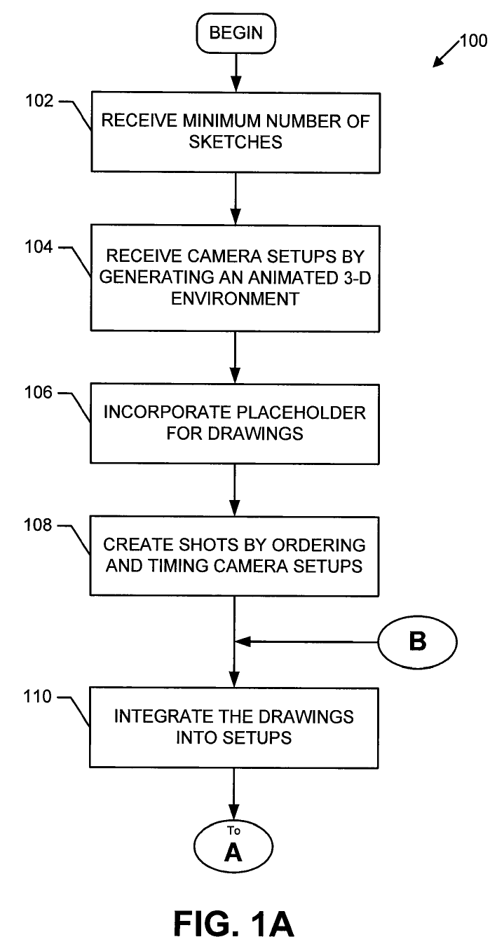

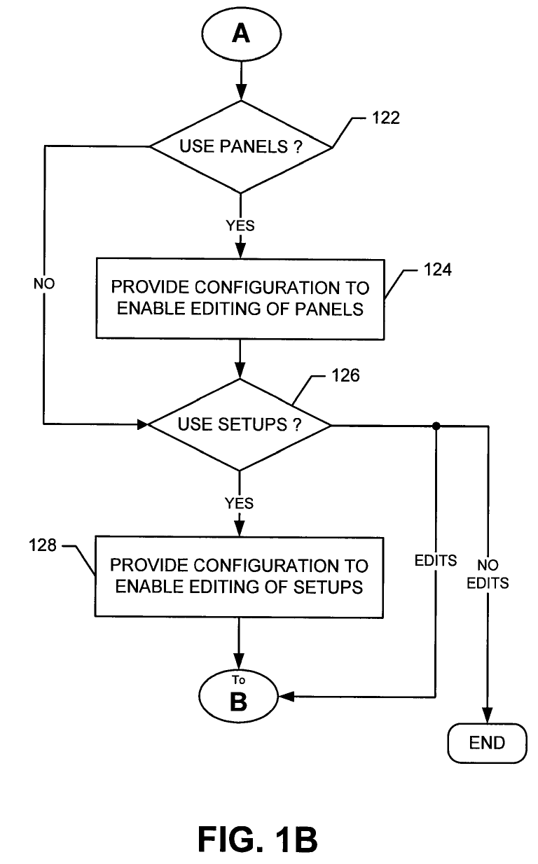

FIG. 1A and FIG. 1B form a flowchart illustrating a story development process 100 in accordance with one implementation of the present invention. Although the story development process, in the illustrated implementation, is used to develop and/or analyze a story in motion picture, this technique can be modified to be used to develop and/or analyze a story in other areas, such as in computer games, commercials, TV shows, music videos, theme park rides, and in forensic visualization.

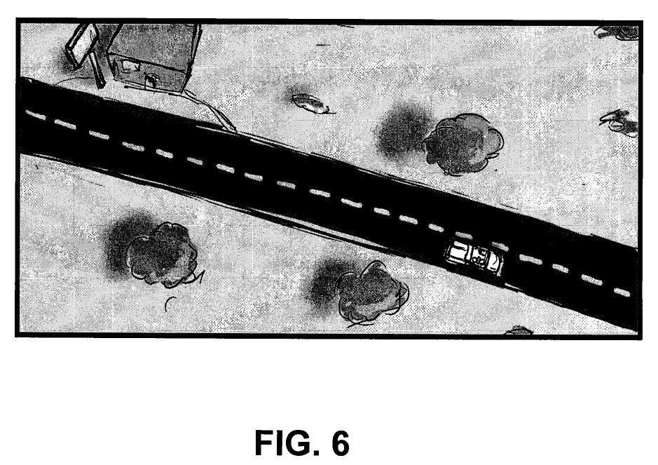

In the illustrated implementation of FIG. 1A, the story development process 100 includes initially receiving a minimum number of drawings describing the action, at box 102. In other implementations, receiving drawings also includes receiving storyboard panels (see FIG. 6 for one example of a storyboard panel) and indications of how these storyboard panels are ordered as indicated in FIG. 5 showing the sequence edit.

In a further implementation, storyboard panels are optional. In this implementation, the 3-D scene or environment exists within a shot, but the shot does not benefit from the addition of any drawn panels or items. Using the car example, the camera may be very far away from the car. Thus, in this example, a shot can be created without the use of drawings.

Camera setups are received, at box 104, by generating an animated 3-D environment, and placeholders for the sketches are incorporated into the generated 3-D environment, at box 106. In one implementation, the generation of an animated 3-D environment includes virtual placement of 3-D models. In another implementation, the generation of 3-D environment is optional. Using one or a combination of the rigs, an artist can skip the generation of a 3-D environment modeling process. A shot can be made up entirely of drawings placed on drawing placeholders and a camera positioned or animated across these placeholders. Drawn panels can be used for shots that do not need any 3-D models. For example, simple dialog shots, or shots that are just being roughed out such that no models or 3-D placeholders have yet been created. If these drawn panels portray an action from the same camera, the panels can be grouped together and the group can be referred to a drawn setup. Each time a portion of this setup is inserted in the sequence edit, that section represents a shot.

The incorporation of placeholders for drawings into the generated 3-D environment includes configuring placeholders (i.e., rigs) with respect to the camera angles. Accordingly, rigs can be configured to behave differently.

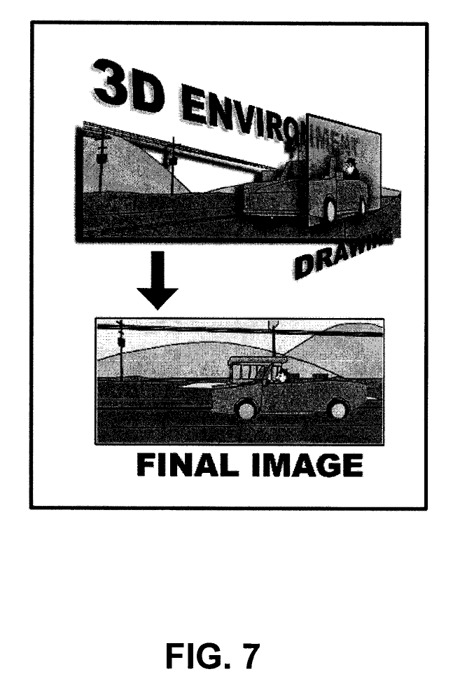

In one implementation, for example, a rig is configured as a billboard rig, where the rig is always turned to face the active camera, as illustrated in FIG. 7. In this implementation, the rig is linked to a 3-D object and the rig is allowed to travel along with that 3-D object. For example, if the billboard rig is linked to a car, and the billboard represents the driver, then the billboard will move along with the car and even tilt up and down along with the car. However, in this implementation, the rig always turns to face the camera. The placement of a pivot point for the rig and the intersection of the pivot point with a 3-D point provide the impression that the drawing touches the 3-D point. For example, placing the pivot point at the feet of the character and moving the car to the ground plane provide the impression that the character is always touching the ground irrespective of the changes in the camera perspective.

In another implementation, a rig is configured as a multi-plane rig, where the rig does not turn to face the camera as the camera moves. Further, the rig includes multiple planes in a 3-D space. Although each plane can be moved further away from the camera, the plane is automatically scaled up as it moves away from the camera. The scaling allows the plane to visually fill the same screen space. Accordingly, the multi-plane rig concept is equivalent to taking a painting, breaking up the background, middle-ground, foreground, and moving the planes (or “grounds”) in 3-D space. Thus, this configuration of the rig allows easy animation of a camera, and the parallax between the drawings provides a dimensional sense of the scene/environment.

In another implementation, a rig is configured as a projection rig, which is similar to the multi-plane rig. The projection rig includes multiple layers of drawings. However, instead of displaying the layers of drawings on the rigs, the drawings are actually projected on relatively simple 3-D models. This configuration of the rig strengthens the dimensionality illusion of the drawing. In yet another implementation, a rig is configured as a UV rig, where the drawing is applied to the UV values of a 3-D model.

In a further implementation, a rig is configured as a camera billboard rig, where the rig is attached to the camera. In this implementation, the rig is always facing the camera, and fills the camera view. The intent of the camera billboard rig is to allow artists to create camera relative additions to a shot. Further, the rig can also be used for any drawn notes or for any quick drawn effects.

Referring again to FIG. 1A, shots are created, at box 108, by ordering and timing camera setups. In one implementation, the timing provides temporal spacing between each shot so that the rate at which the shots are displayed or viewed can be controlled. In another implementation, the timing of the setup is made optional. By adding the concept of panels, timing is decoupled from the 3-D animation. Each panel represents, each drawn keyframe, and the first frame of each shot. A frame becomes a keyframe when an artist attaches a new drawing or new dialogue to a placeholder of that particular frame. This implementation allows the storyboard artists to step through each panel in the sequence and the player displays a larger view of the currently selected panel. Accordingly, the storyboard artist can avoid timing and playing the entire motion picture by manually advancing from one panel to the next panel.

At box 110, drawings are integrated into setups. In one implementation, the integration of the drawings into the 3-D setup includes incorporating each storyboard or drawing panel into a placeholder within each corresponding scene. This process assumes that the timing for the generated 3-D action is same as the timing for the drawings. However, in an alternative implementation, box 110 is processed before box 108 so that the timing for the 3-D action (at box 108) is performed after the drawings are integrated with the setups (at box 110).

Referring to FIG. 1B, configurations are provided to enable editing of panels (at box 124) and/or setups in the sequence (at box 128) depending on the result of queries at boxes 122 and 126. For example, in one implementation, a configuration is provided to enable a storyboard artist to use held frames from a 3-D setup, or use drawn panels as part of the sequence edit. In another example, a configuration is provided to enable a 3-D artist to use the animated setup.

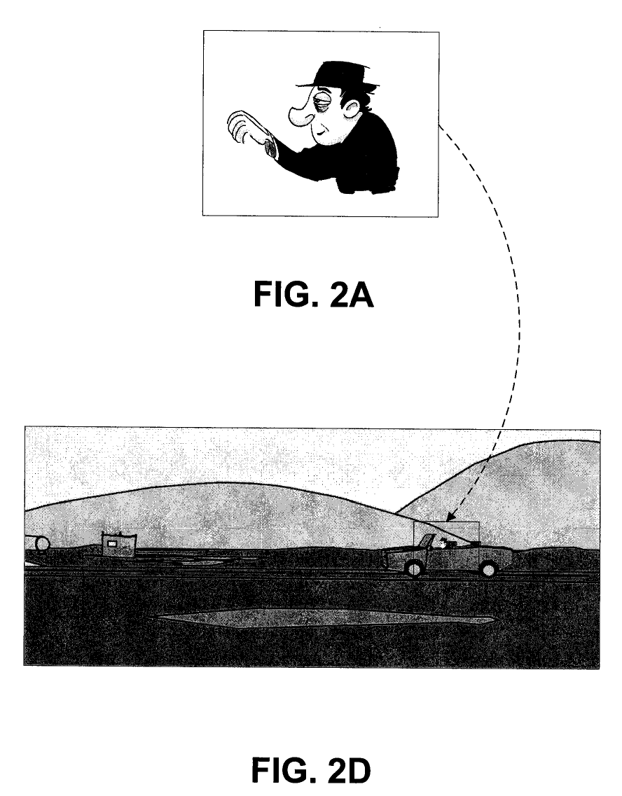

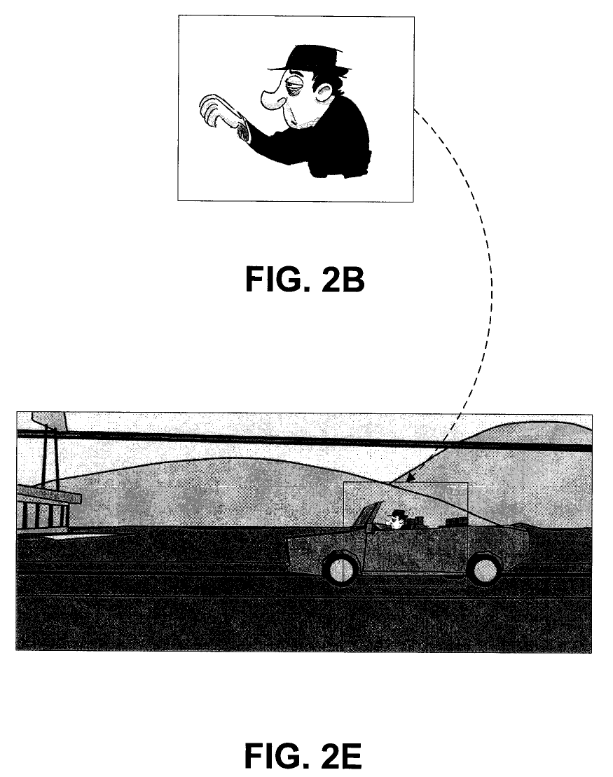

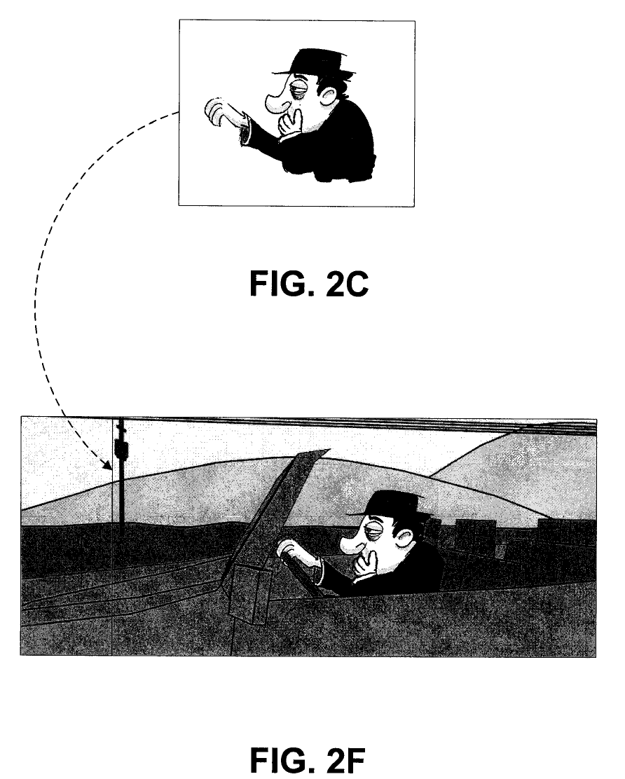

FIG. 2A through FIG. 2F illustrate one example of drawings, 3-D setups, and integration of those drawing into a 3-D scene.

FIG. 2A through FIG. 2C are three storyboard panels drawn by a storyboard artist showing a person driving a car. Each panel shows different expressions. FIG. 2A shows the person with relatively happy expression as he drives his car. FIG. 2B shows the person beginning to get more serious. FIG. 2C shows the person placing his hand over his mouth.

FIG. 2D through FIG. 2F represent an animated 3-D setup, and because it includes three expressions, the setup can also be considered to include three panels. Within each panel the size of the placeholder rig, is relative to the size and the position of the object it represents. FIG. 2D shows a wide angle scenery with a relatively small placeholder for incorporating the drawing of FIG. 2A. FIG. 2E shows a closeup of the car with a relatively large placeholder for the drawing of FIG. 2B showing the driver. FIG. 2F shows a closeup of the driver.

It can be seen from the above example implementation that the drawn panels and the 3-D setups can easily be edited as shots within a sequence. Accordingly, the story development process as described above allows storyboard artists, editors, modelers, and layout artists to conceptualize the motion picture in the early stage.

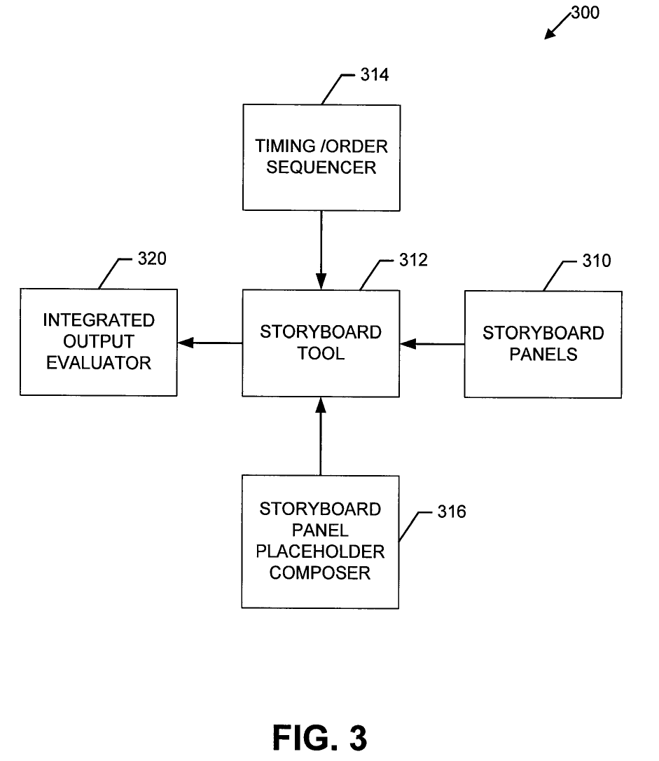

FIG. 3 is a block diagram of a story development system 300 in accordance with one implementation of the present invention. In the illustrated implementation, the story development system 300 includes storyboard panels 310, a storyboard tool 312, a placeholder composer 314, a timing/order sequencer 316, and an integrated output evaluator 320. In one implementation, the storyboard panels 310 include sketches and/or drawings. In another implementation, the storyboard panels also include edits or indications of how these storyboard panels are ordered.

In a further implementation, the storyboard panels 310 are optional. In this implementation, the 3-D scene or environment exists within a shot, but the shot does not benefit from the addition of any drawn panels or items. For example, an environment fly through may not need drawn panels or items. Thus, in this example, a shot can be entirely rendered by the storyboard tool.

The storyboard tool 312 generates a scene (or environment sequence), which includes virtual placement of 3-D cameras and setup of 3-D models. In one implementation, the storyboard tool 312 is optional. That is, a shot can be made up entirely of drawing panels and a camera. Using one or a combination of the rigs, an artist can skip the generation of a scene sequence (“modeling process”), and even the 3-D process. Drawing panels can be used for shots that do not need any scene sequence. For example, simple dialog shots, or shots that are just being roughed out such that no models have yet been created.

The storyboard panel placeholder composer 314 incorporates placeholders for storyboard panels into the generated scene (e.g., shots) generated by the storyboard tool 312. The incorporation of placeholders for storyboard panels into the generated scene sequence includes configuring rigs or placeholders with respect to the camera angles.

The timing/order sequencer 316 generates timing for the sequenced scenes. In one implementation, the timing provides temporal spacing between each sequenced scene so that the rate at which the scenes are displayed or viewed can be controlled.

The storyboard tool 312 also integrates the storyboard poses into the generated 3-D scene. In one implementation, the tool 312 attaches each storyboard or drawn pose into a placeholder within the corresponding 3-D scene. However, in an alternative implementation, the timing/order sequencer 316 performs the timing for the sequenced scenes after the rendering of a 3-D scene. This is achieved by storing positional information of each placeholder relative to the camera and matching the position of each drawing in a 2-D compositing process.

The storyboard tool 312 is further configured to edit panels and/or poses in the sequence. For example, in one implementation, a configuration is provided to enable a storyboard artist to edit panel(s) directly on the integrated shots. In another example, another configuration is provided to enable a 3-D artist to edit the poses or placement of rigs directly on the integrated shots.

The integrated output evaluator 320 such as a display is used to output and evaluate the integrated shots.

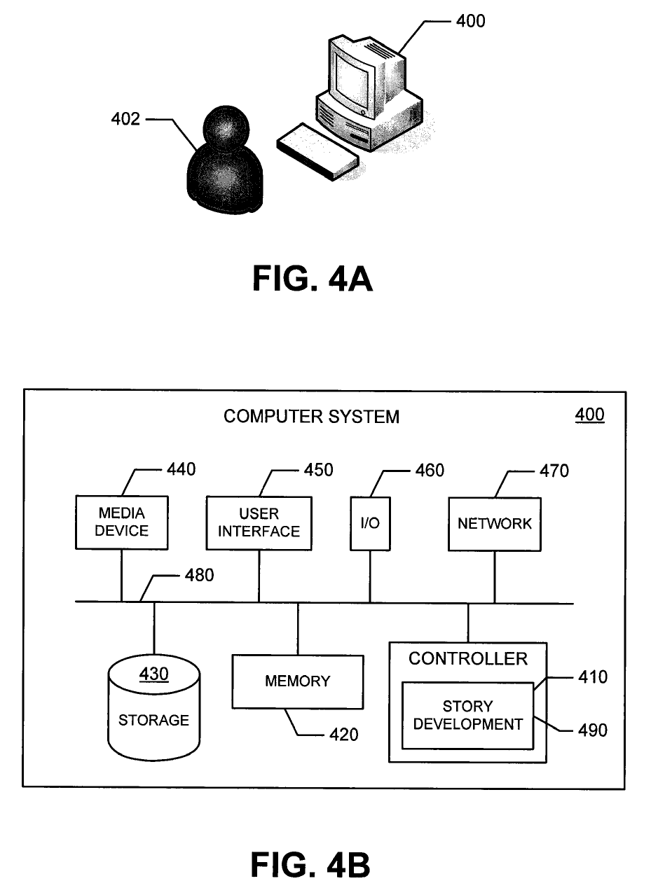

FIG. 4A illustrates a representation of a computer system 400 and a user 402. The user 402 uses the computer system 400 to perform story development. The computer system 400 stores and executes a story development system 490.

FIG. 4B is a functional block diagram illustrating the computer system 400 hosting the story development system 490. The controller 410 is a programmable processor and controls the operation of the computer system 400 and its components. The controller 410 loads instructions (e.g., in the form of a computer program) from the memory 420 or an embedded controller memory (not shown) and executes these instructions to control the system. In its execution, the controller 410 provides the story development system 490 as a software system. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data temporarily or long term for use by other components of the computer system 400, such as for storing data used by the story development system 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user. In one implementation, the user interface 450 includes a keyboard, a mouse, audio speakers, and a display. The controller 410 uses input from the user to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

The story development system allows each artist to continue to use the same software that the artist has been using previously. This compatibility is possible because the story development system, in one implementation, is supported by three main components: a cross-platform interface; an XML-based data file; and a python module; which allows all applications use the same code library for modifying shots. Further, the interface is built in Macromedia Flash so that it can run on any platform that supports a Flash player.

Various implementations are or can be implemented primarily in hardware using, for example, components such as application specific integrated circuits (“ASICs”), or field programmable gate arrays (“FPGAs”). Implementations of a hardware state machine capable of performing the functions described herein will also be apparent to those skilled in the relevant art. Various implementations may also be implemented using a combination of both hardware and software.

Furthermore, those of skill in the art will appreciate that the various illustrative logical blocks, modules, connectors, data paths, circuits, and method steps described in connection with the above described figures and the implementations disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, connectors, data paths, circuits, and method steps described in connection with the implementations disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. A storage medium can be coupled to the processor such that the processor can read information from, and write information to, the storage medium. In the alternative, the storage medium can be integral to the processor. The processor and the storage medium can also reside in an ASIC.

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Thus, it is to be understood that the description and drawings presented herein represent a presently preferred implementation of the invention and are therefore representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of developing a story for a motion picture, the method comprising:
receiving drawings;
receiving camera setups by generating an animated 3-D environment;
incorporating placeholders for the drawings into the generated 3-D environment;
creating shots by ordering and timing the camera setups; and
integrating the drawings into the camera setups.

2. The method of claim 1, wherein the generation of an animated 3-D environment includes virtual placement of 3-D models.

3. The method of claim 1, wherein incorporating placeholders for drawings into the generated 3-D environment includes configuring the placeholders with respect to camera angles.

4. The method of claim 3, wherein configuring the placeholders with respect to camera angles includes configuring a rig to always turn to face a camera.

5. The method of claim 4, wherein the configuration of the rig is linked to a 3-D object, and the rig is allowed to travel along with the 3-D object.

6. The method of claim 3, wherein configuring the placeholders with respect to camera angles includes configuring a rig as a multi-plane rig, which does not turn to face the camera as the camera moves.

7. The method of claim 3, wherein configuring the placeholders with respect to camera angles includes configuring a rig including multiple layers of drawings.

8. The method of claim 7, wherein the layers of drawings are projected on 3-D models to strengthen dimensionality illusion of the drawings.

9. The method of claim 3, wherein configuring the placeholders with respect to camera angles includes configuring a rig, wherein the rig is attached to the camera, is facing the camera, and fills a view of the camera.

10. The method of claim 1, wherein timing the camera setups provides temporal spacing between the shots to control the rate at which the shots are displayed or viewed.

11. The method of claim 1, wherein receiving drawings includes receiving storyboard panels and indications of how the storyboard panels are ordered in a sequence edit.

12. The method of claim 1, wherein integration of the drawings includes incorporating a storyboard or drawing panel into a placeholder within a corresponding scene.

13. The method of claim 1, further comprising providing configurations to enable editing of panels and setups.

14. A method of developing a story for a motion picture, the method comprising:
receiving drawings and camera setups;
incorporating placeholders for the drawings;
creating shots using position and timing of the camera setups; and
integrating the drawings into the camera setups.

15. The method of claim 14, wherein the created shots include simple dialog shots or shots for which no models or 3-D placeholders have yet been created.

16. A system for developing a story for a motion picture, the system comprising:
a plurality of storyboard panels;
a storyboard tool configured to generate 3-D scenes, wherein a 3-D scene includes virtual placement of 3-D cameras and setup of 3-D models; and
a placeholder composer configured to incorporate placeholders for the plurality of storyboard panels into the generated scene.

17. The system of claim 16, wherein incorporating placeholders for storyboard panels by the placeholder composer includes configuring rigs or placeholders with respect to camera angles.

18. The system of claim 16, further comprising
a timing/order sequencer configured to generate timing for the 3-D scenes,
wherein the timing provides temporal spacing between the 3-D scenes so that the rate at which the 3-D scenes are displayed or viewed is controlled.

19. The system of claim 16, wherein the storyboard tool includes an integrator to integrate storyboard poses into the generated 3-D scenes.

20. The system of claim 16, wherein the storyboard tool includes an editor to edit shots in the 3-D scenes.

21. The system of claim 16, further comprising an integrated output evaluator configured to evaluate the edited shots.

22. A computer-readable storage medium storing a computer program for developing a story for a motion picture, the computer program comprising executable instructions that cause a computer to:
generate an animated 3-D environment when digitized drawings and camera setups are received;
incorporate placeholders for the digitized drawings into the generated 3-D environment;
create shots by ordering and timing the camera setups; and
integrate the digitized drawings into the camera setups.

23. The storage medium of claim 22, wherein the generation of an animated 3-D environment includes virtual placement of 3-D models.

24. The storage medium of claim 22, wherein the executable instructions that cause a computer to incorporate placeholders for drawings include executable instructions that cause a computer to
configure the placeholders with respect to camera angles.

25. The storage medium of claim 22, wherein timing the camera setups provides temporal spacing between the shots to control the rate at which the shots are displayed or viewed.

26. The storage medium of claim 22, wherein the executable instructions that cause a computer to integrate the drawings include executable instructions that cause a computer to
incorporate a storyboard or drawing panel into a placeholder within a corresponding scene.
